(19) United States
(12) Patent Application Publication
(10) Pub. No.: US 2009/0056544 A1
(43) Pub. Date: Mar. 5, 2009

(54) METHODS AND APPARATUS FOR ABATING ELECTRONIC DEVICE MANUFACTURING TOOL EFFLUENT

(75) Inventor: Robbert M. Vermeulen, Pleasant Hill, CA (US)

Correspondence Address: DUGAN & DUGAN, PC, 245 Saw Mill River Road, Suite 309, Hawthorne, NY, 10532, US

(73) Assignee: APPLIED MATERIALS, INC., Santa Clara, CA (US)

(21) Appl. No.: 12/202,219

(22) Filed: Aug. 29, 2008

Related U.S. Application Data
(60) Provisional application No. 60/969,601, filed on Aug. 31, 2007.

(51) Int. Cl. B01D 47/00

(52) U.S. Cl. 95/227; 96/262

(57) ABSTRACT

An electronic device manufacturing tool effluent abatement system is provided, including a thermal abatement reactor adapted to abate an effluent stream, and an eductor adapted to receive the effluent stream from the thermal abatement reactor. Numerous other embodiments are provided.

The present application claims priority to U.S. Provisional Patent Application Ser. No. 60/969,601, filed Aug. 31, 2007 and entitled “METHODS AND APPARATUS FOR ABATEMENT WITH A FLUID EDUCTOR” (Attorney Docket No. 12701/L), which is hereby incorporated herein by reference in its entirety for all purposes.

### FIELD OF THE INVENTION

The present invention relates generally to electronic device manufacturing, and is more particularly directed to the abatement of electronic device manufacturing tool effluent.

### BACKGROUND OF THE INVENTION

Undesirable chemical species which may be exhausted from electronic device manufacturing tools are typically abated, e.g., converted into species which are acceptable for release to the atmosphere, or which may be subjected to further abatement. A typical effluent stream from an electronic device manufacturing tool may be subjected to several abatement processes before being sent to a house exhaust from which it may be released to the atmosphere. For example, an effluent stream may be subjected to one or more of a thermal unit, a burn unit, an electrically heated oxidation unit, a plasma unit, a water scrubber, a catalytic unit, etc.

One form of abatement includes oxidizing undesirable species to form species which are acceptable to release into the atmosphere, or species which may be abated by downstream abatement processes. Although oxidation abatement may be very effective, oxidation of undesirable species may produce particulate materials which may be unacceptable to release into the atmosphere, or which may reduce the efficiency, or otherwise harm, downstream abatement equipment. It is therefore desirable to remove particulate materials from an effluent stream before the particulate materials enter the atmosphere, or downstream abatement equipment and/or processes which may be harmed or otherwise adversely affected by the particulate materials.

### SUMMARY OF THE INVENTION

In one aspect, an electronic device manufacturing tool effluent abatement system is provided, including a thermal abatement reactor adapted to abate an effluent stream; and an eductor adapted to receive the effluent stream from the thermal abatement reactor.

In another aspect, a method for abating effluent from an electronic device manufacturing tool is provided, including the steps oxidizing the effluent in a thermal oxidation abatement reactor, and scrubbing the effluent from the thermal abatement reactor in an eductor.

Numerous other aspects are provided in accordance with these and other aspects of the invention. Other features and aspects of the present invention will become more fully apparent from the following detailed description, the appended claims and the accompanying drawings.

### BRIEF DESCRIPTION OF THE DRAWINGS

FIG. 1 is a side cross section view of an eductor abatement apparatus provided in accordance with the present invention.

FIG. 2 is a side schematic view of oxidation/eductor abatement system provided in accordance with the present invention.

FIG. 3 is a schematic view of another oxidation/eductor abatement system provided in accordance with the present invention.

FIG. 4 is a schematic view of another oxidation/eductor abatement system provided in accordance with the present invention.

FIG. 5 is a flowchart depicting a method for abating electronic device manufacturing tool effluent in an oxidation/eductor abatement system in accordance with the present invention.

FIG. 6 is a flowchart depicting another method for abating electronic device manufacturing tool effluent in an oxidation/eductor abatement system in accordance with the present invention.

### DETAILED DESCRIPTION

Undesirable chemical species may be removed from the effluent stream of an electronic device manufacturing tool by oxidizing the undesirable species to form species which may be released to the atmosphere, or to form species which may be treated and/or removed from the effluent stream by downstream abatement systems. Such non-oxidation of abatement systems may include wet scrubbers, dry resin beds, catalytic abatement reactors and/or other systems.

As stated above, one problem associated with oxidation reactors is that an oxidation reaction may create particulates which may exceed local emissions limits, clog or reduce the efficiency of downstream abatement systems such as, for example, wet scrubbers, dry resin beds, or catalytic units, etc. It may therefore be desirable to remove particulates from the effluent stream of an oxidation reactor.

In one aspect, the present invention provides an eductor abatement apparatus (hereinafter referred to as “an eductor”) which may be very effective to remove particulate materials from an effluent stream. The eductor may operate by creating a low-pressure zone inside of the eductor into which the effluent stream may be pushed or pulled. The low-pressure inside the eductor may be created by a forceful spray of fluid into the eductor, which, for example, may be a tube which may comprise a narrow waist and bell shape. The spray of fluid inside the eductor may create a venturi effect which may draw the effluent stream (e.g., pull the effluent stream, or enable the effluent stream to be pushed) into the eductor. Inside the eductor, the effluent stream may intermingle with the sprayed fluid and be ejected through a discharge port of the eductor. The relatively high velocity, turbulence and fine droplets of the fluid spray may increase the probability of contact between the particulates and the scrubbing stream fluid. When the effluent stream intermingles with the fluid, particulates in the effluent stream may be much more likely to become entrained in the fluid, and pass with the fluid, e.g., be knocked down, into a retention or fluid management vessel (hereinafter referred to as a ‘tank’). The effluent, from which the particulates have been knocked down, may depart the fluid and pass to further abatement apparatus or to the atmosphere.

In another aspect, the present invention provides an electronic device manufacturing tool effluent abatement system which may include an oxidation reactor and an eductor abatement apparatus. In this embodiment of the invention, the eductor may be connected to the outflow of the oxidation reactor via an effluent conduit which may be inclined up, e.g., not horizontal, to create an obstacle for liquids and/or particulates. The incline of the effluent conduit may make it difficult for liquids and larger or heavier particulates to enter the eductor through a suction or effluent port. This may be beneficial, as it may help the eductor to avoid becoming clogged or otherwise becoming less efficient. As described above, the eductor may create a low-pressure zone or suction within the eductor which may draw effluent up through the effluent conduit and into the eductor. Depending upon the strength of the suction, and the inclination angle, length and shape of the effluent conduit, the abatement system may be designed and operate to prevent no more than a predetermined amount of fluid, and particles of no larger than a predetermined size, from entering the eductor.

In other aspects, the abatement system described above may be combined with further upstream or downstream abatement systems, such as packed bed water scrubbers, and catalytic units, etc., for further treatment of the effluent stream.

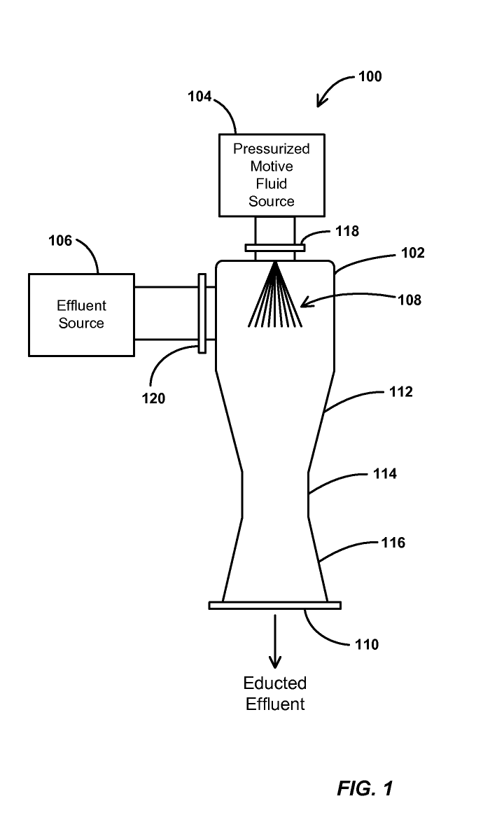

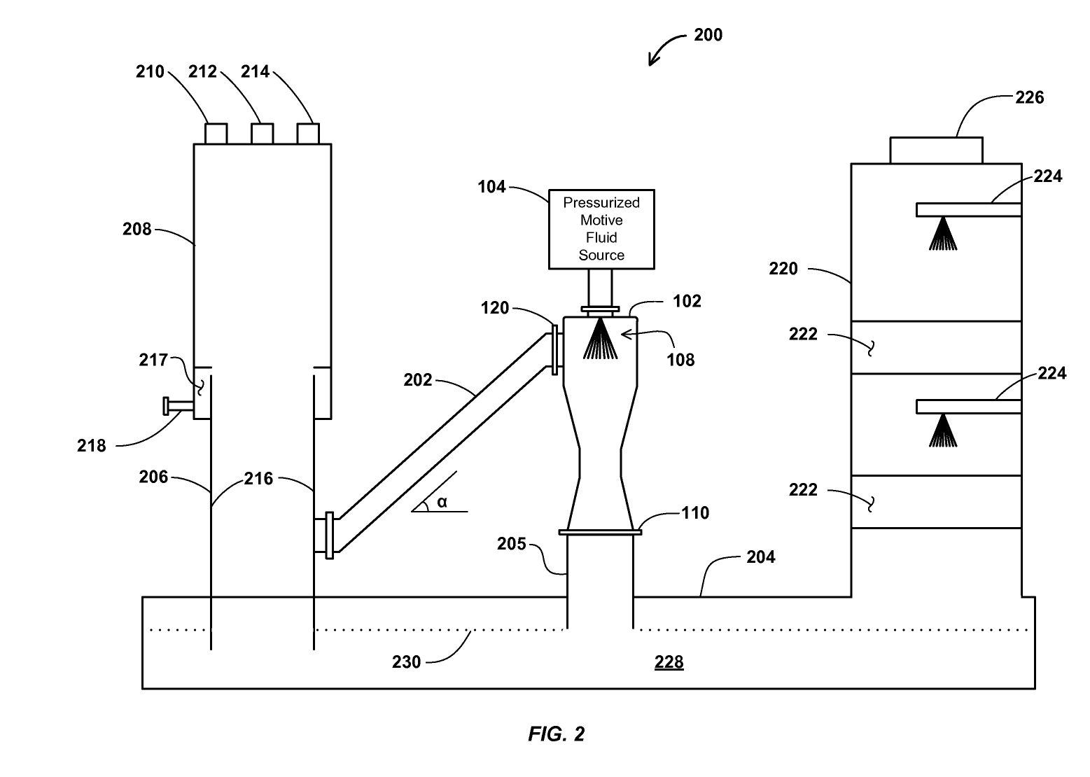

FIG. 1 is a side cross section view of an eductor abatement apparatus 100 provided in accordance with the present invention. The eductor abatement apparatus 100 may include an eductor 102 that may be coupled to a pressurized motive fluid source 104 and an effluent source 106. The eductor 102 may also include a spray nozzle (not shown) through which the motive fluid may be forced to form an eductor spray 108. As depicted, the eductor 102 has an outlet or exhaust port 110 that may exhaust effluent which has been processed or scrubbed by the eductor 102. The exhaust port 110 may be connected to an educted effluent conduit (not shown in FIG. 1) as described below with reference to FIGS. 2, 3 and 4.

The eductor 102 shown in FIG. 1 may also include a narrowing section 112, a waist 114, and a widening section or bell 116. The narrow waisted shape may result in an efficient eductor, as measured by the strength of the eductor suction as a function of the eductor motive fluid pressure, and the removal of particulates from the effluent stream. Any other suitable eductor shape, such as a simple tube, etc., may also be employed. Motive fluid from the motive fluid source 104 may enter the eductor through a motive fluid port 118. Effluent from the effluent source 106 may enter the eductor through an effluent port 120.

With reference to FIG. 1, the eductor 102 may be a water based eductor although any suitable device (e.g., jet-apparatus) may be employed. Any fluid with an affinity for the particulate materials may be employed. The eductor 102 may be, for example, a TLG Series® jet-apparatus provided by Elmridge Inc. of Livonia, Mich., although any practicable product or device may be employed. The water based educator may be employed to process effluent in accordance with the present invention.

Still with reference to FIG. 1, a pressurized motive fluid source 104 may be a source of pressurized water. Although water may be used for illustrative purposes herein, it will be understood that any suitable fluid may be used. For example, in one embodiment, steam (from a source external to the eductor) may be used as the fluid. In some embodiments the effluent stream which enters the eductor may have a thermal mass sufficient to convert at least some of the motive fluid into steam. The pressurized motive fluid source 104 may be a source of deionized water with a pressure of about 60 pounds per square inch (p.s.i.), although any suitable pressure may be employed. The pressurized water may be supplied by a fabrication plant's facilities, although any suitable source of pressurized water may be employed.

With reference to FIG. 1, the effluent source 106 may be a source of electronic device fabrication tool effluent, although any suitable source of effluent may be employed. The effluent may include particulates (e.g., particles small enough to be suspended in the effluent, and larger particles that may sink in water, etc.), liquids, and gases, etc. Some or all of such effluent may be processed by the eductor 102, as will be described in more detail below.

Still with reference to FIG. 1, the eductor spray 108 may be a spray of the pressurized motive water, although any suitable fluid may be employed. For example the fluid may be a mixture of chemicals and water that may be useful in the certain embodiments of the invention. As depicted, the spray is triangular in cross-section, or conical in three dimensions, although any suitable shape may be employed. Additionally, the spray is depicted as pointed in the direction of the outlet of the eductor 102 although any suitable direction may be employed.

In operation, the motive fluid from the pressurized motive fluid source 104 may be forced through the motive fluid connection 118 and the nozzle (not shown) to form the eductor spray 108. The eductor spray 108 may perform at least the following functions. The eductor spray 108 may reduce the pressure within the eductor 102 as compared to the pressure within the eductor 102 when the eductor spray 108 is not operating. If the reduction of pressure within the eductor 102 is sufficient to lower the pressure within the eductor 102 below a pressure of the effluent within the effluent source 106, the effluent may be drawn (for example, may be pushed and/or pulled) from the effluent source 106 through the effluent port 120 into the eductor 102. The effluent which is pushed/pulled into the eductor 102 may then be carried by the effluent spray 108 and/or gravity through the body of the eductor and out the exhaust port 110.

The eductor spray 108 may also serve to intermingle with the effluent which may be drawn into the eductor 102. The intermingling of the eductor spray 108 with the effluent may serve to knock particulates out of the effluent and/or entrain particulates within the motive fluid. The narrowing of the eductor 102 in narrowing section 112 to form the waist 114 may ensure that no significant portion of the effluent may avoid becoming intermingled with the motive fluid which may form the eductor spray 108. The intermingling of the eductor spray 108 with the effluent may also serve to humidify the effluent and remove water soluble undesirable species, which may be beneficial if the effluent is to be routed through a catalytic unit or another abatement apparatus.

The pressure of the effluent inlet 120 may reflect the eductor 102 internal pressure, and may range broadly. Any practicable pressure may be employed. For example, the eductor spray 108 may be a spray of pressurized water that enters the eductor 102 at about 60 p.s.i. although any suitable pressure may be employed. As depicted, the eductor 102 may draw (e.g., push and/or pull) the effluent into the eductor 102 from the effluent source 106 in accordance with the present invention.

Not wishing to be bound by any particular theory, the eductor 102 may operate to remove particulate materials from the effluent by intermingling the fluid spray 108 with the effluent from effluent source 106. It may be that the narrowing portion 112 of the eductor 102 makes it unlikely that a significant portion of the effluent may pass through the eductor 102 without becoming intermingled with the fluid spray 108. In addition, the narrowing section 112, followed by the waist 114 and the widening area 116, may serve to increase the efficiency of drawing the effluent from the effluent source 106 by the eductor. In addition, in some embodiments, where the motive fluid is steam or another vaporized liquid, or where at least a portion of the motive fluid is converted to steam or another vaporized liquid by the effluent stream, the steam or other vaporized liquid may be more effective to knock down smaller particulates than would a liquid motive fluid. The mechanism may be that the steam condenses on particles, making them more likely to become entrained in liquid or more likely to adhere to other particles. For example, the liquid vapor may quickly condense as the temperature of the effluent falls below the liquid's boiling point. The liquid vapor may condense and nucleate droplets on finer particulate, making them heavier and larger. Heavier and larger particles trapped in a fluid droplet may be more easily scrubbed by subsequent processing.

FIG. 2 is a side schematic view of an oxidation/eductor abatement system 200 provided in accordance with the present invention. The abatement system 200 may include the eductor 102 of FIG. 1. The eductor 102 may be coupled to an effluent pipe 202 and may be coupled or in fluid communication with a tank 204 through an eductor scrubbed effluent conduit 205. The effluent pipe 202 may be a straight pipe or may have one or more curved sections and one or more bends, and may be vertical or be inclined from vertical. The incline from vertical of the effluent pipe 202 may be between about 1 and about 89 degrees, between about 3 and about 60 degrees, or between about 5 and about 45 degrees. In some embodiments the effluent pipe 202 may be inclined from the vertical between about 5 and about 15 degrees, or about 10 degrees.

The eductor scrubbed effluent conduit 205 may be optional, and the outlet 110 of the eductor 102 may be positioned within or connected directly to the tank 204. The effluent pipe 202 may be coupled to a waterfall pipe 206 to provide a conduit through which effluent and/or abated effluent may be conveyed from the waterfall pipe 206.

As depicted, the waterfall pipe 206 may be coupled to a reactor 208 that may have inputs 210, 212, 214 that may be coupled to a fuel supply (not shown), an effluent source (not shown), and an oxidant source (not shown), respectively. As described above the reactor may be any suitable thermal oxidation reactor, such as, for example, a burn, electro-thermal or plasma apparatus, etc. The waterfall pipe 206 may also include a waterfall (not shown) that may provide a film of water along an interior wall 216 of the waterfall pipe 206. The water which forms the waterfall (not shown) may enter a reservoir 217 through fitting 218. The water may well up and over an interior wall of the reservoir 217 and flow down the interior wall 216 of the waterfall pipe 206.

The eductor 102 may be coupled to a bed scrubber 220 (via the tank 204) that may further scrub or process the effluent and/or abated effluent. The bed scrubber 220 may include one or more packed beds 222 and bed sprays 224 that may further process the effluent. The packed beds 222 may be filled with beads of any suitable material, or with any other suitable material of any suitable shape which may serve to increase the contact between the water and the effluent. The bed sprays 224 may receive water or other suitable fluid from the same or from different sources. For example, the bed sprays may both receive the water from the tank 204 through a pump (not shown) and conduit (not shown). Alternatively, one or both of the bed sprays 224 may receive water from another source, such as a plant facilities connection. Receiving water from such other source may serve to replace any water taken from tank 204 for treatment and/or abatement.

As depicted, the scrubbed effluent may exit the bed scrubber 220 at a scrubber exhaust 226 from which the effluent may be directed to a further abatement system (not shown), to a facility exhaust (not shown) or to the atmosphere. Any suitable exhaust may be employed.

The tank may contain a fluid 228 with a fluid surface 230. The fluid 228 may be water or any other suitable fluid.

In operation, effluent from an electronic device manufacturing tool may enter the reactor 208 through inlet 212. Fuel and oxidant may enter the reactor 208 through fuel inlet 210 and oxidant inlet 214. The effluent may be oxidized in the reactor 208 and pass into the waterfall pipe 206. The waterfall (not shown), which may flow from the reservoir 217 and down the interior wall 216 of the waterfall pipe 206, may prevent particulates from collecting on the interior wall 216. From the waterfall pipe 206, a portion of the effluent may flow up through the inclined effluent pipe 202 and into the eductor 102.

Oxidation reactors such as reactor 208 may typically be operated at subatmospheric pressures. This may be done so that if an exterior wall of the oxidation unit 208, or an exterior wall of a waterfall pipe 206, becomes breached, air from the fabrication plant may flow into the oxidation unit rather than effluent from the oxidation unit flowing into the atmosphere of the plant. In order to cause abated effluent to flow from the reactor 208 through the waterfall pipe 206 and into the effluent pipe 202, the pressure within the eductor 102 may need to be reduced below the pressure within the reactor 208 and/or the waterfall pipe 206. As discussed above with reference to FIG. 1, the pressure within the eductor 102 may be reduced by flowing motive fluid from the pressurized motive fluid source 104 through the eductor nozzle (not shown) to form the eductor spray 108. The abated effluent may thus be drawn up the effluent pipe 202 by the reduced pressure inside the eductor 102 which may have been induced by the eductor spray 108.

As described above, the abated effluent may contain particulates and liquids. For example, if the electronic device manufacturing tool effluent contains silane, the effluent from the oxidation reactor 208 may contain silicon oxides. In addition, water from the waterfall lining the interior walls 216 of the waterfall pipe 206 may also be drawn into the effluent pipe 202. As also described above, it may be desirable to prevent, or filter, at least some larger sized particulates, for example those above a certain weight or diameter, from entering the eductor through the effluent port 120. Without such removal and/or filtering of the effluent, the eductor 102 may operate in a less than optimal manner (e.g., reduced operating time between preventative maintenance operations, or less than desirable effluent processing, etc.).

In some embodiments of the invention, the oxidation/eductor abatement system 200 may be designed with an upwardly inclined abated effluent pipe 202. Due to the angle or incline of the effluent pipe 202, some portions of the effluent (e.g., heavier portions, larger particles, etc.) may not be drawn into the eductor 102 by the reduced pressure at the effluent port 120. Accordingly, such portions of the effluent may slide or fall down the effluent pipe 202 into the waterfall pipe 206. By modulating the pressure within the eductor 102, e.g., at the suction port 120, the abatement system 200 may be designed to draw a desired fraction of the effluent flow into the eductor 102. For example, by decreasing the pressure in the eductor 102 at the suction port 120 (and thus increasing the suction) the abatement system 200 may be designed to draw heavier and/or larger particles, and liquids into the eductor 102 from the effluent pipe 202. Conversely, by increasing the pressure in the eductor at the suction port 120 (and thus decreasing the suction) the abatement system 200 may be designed to let heavier and/or larger particles, and liquids fall back through the effluent pipe 202 into the waterfall pipe 206 and from there into the tank 204. Accordingly, the effluent that reaches the eductor 102 may be processed in a manner similar to that discussed with reference to FIG. 1.

The internal pressure of the eductor 102 may be controlled by controlling the pressure of the motive fluid and thereby controlling the force of the eductor spray 108. By increasing the pressure of the motive fluid, the force of the eductor spray 108 may be increased. Conversely, by decreasing the pressure of the motive fluid, the force of the eductor spray 108 may be decreased. In general, an eductor spray 108 of a greater force will create a lower pressure within the eductor 102 than will an eductor spray 108 of a lesser force.

As described above, the pressurized motive fluid source 104 may be a fabrication facility source, or any other appropriate source.

In addition to modifying the pressure in the eductor 102 at the suction port 120, the length and/or the inclination angle α of the effluent pipe 202 may be varied. For example, for a given eductor 102 pressure, a longer effluent pipe 202 may “filter out” and prevent entry into the inductor of more heavier and/or larger particles and liquids than may a shorter effluent pipe 202. Similarly, for a given eductor 102 pressure, a larger inclination angle alpha of the effluent pipe 202 may “filter out” and prevent entry into the inductor of more heavier and/or larger particles and liquids than may an effluent pipe 202 having a smaller inclination angle.

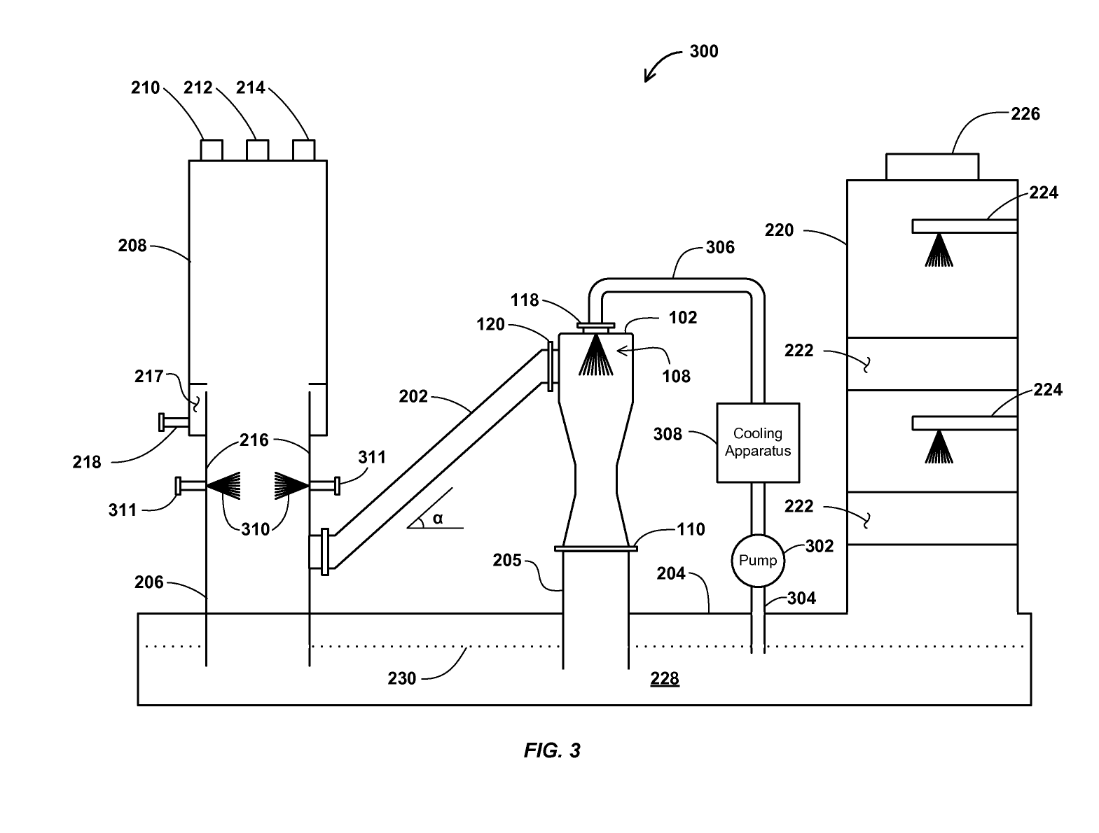

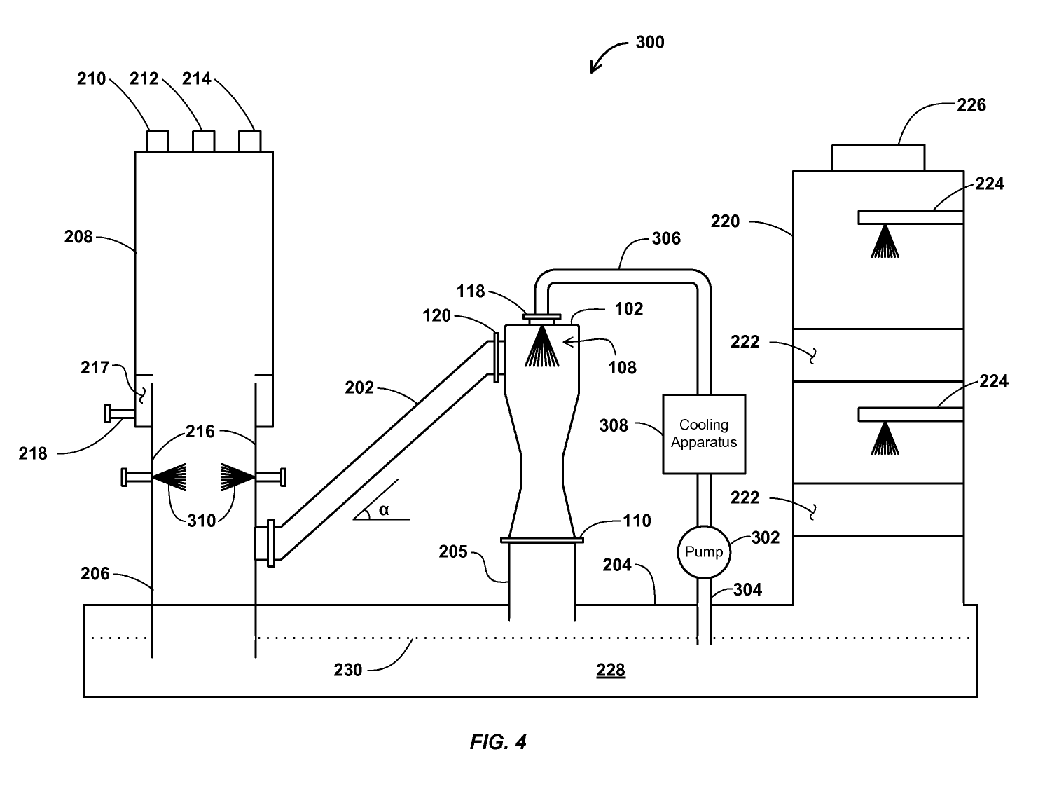

Still with reference to FIG. 2, the eductor scrubbed effluent may flow from the conduit 205 and may enter the tank 204 at or near the fluid surface 230. As depicted, the outlet of the conduit 205 is at approximately the same level as the fluid surface 230 of the tank 204, although the outlet of the conduit 205 may be above or below the fluid surface 230. Such embodiments are described below with reference to FIGS. 3 and 4. After exiting the eductor 102, the scrubbed effluent may pass through the tank 204 and through the bed scrubber 220 toward the scrubber exhaust 226. The bed scrubber 220 may further scrub the effluent prior to the scrubbed effluent exiting the bed scrubber 220 at the scrubber exhaust 226. Although a bed scrubber is depicted, any other suitable further processing and/or abatement of the effluent may be performed in place of, or in addition to, the bed scrubber 220.

FIG. 3 is a schematic side view of another oxidation/eductor abatement system 300 provided in accordance with the present invention. As depicted, the abatement system 300 may include many of the components described with reference to FIGS. 1 and 2. Such components will be referred to herein with the reference numerals used in FIGS. 1 and 2. In addition to such components, the third exemplary eductor abatement system 300 may include a recycling pump 302 that may be coupled to the tank 204 through a pump conduit 304. The pump conduit 304 may extend into the tank 204 to below the fluid surface 230. The recycling pump 302 may be coupled to a motive fluid pipe 306 that may be coupled to the eductor 102 at motive fluid port 118. Optionally, the motive fluid pipe 306 may pass through a cooling apparatus 308. Cooling apparatus 308 may be a heat exchanger, or any other suitable cooling apparatus.

As discussed above with reference to FIG. 2, the eductor 102 may be supplied effluent by the reactor 208 through the waterfall pipe 206. The waterfall pipe 206 may include water sprays 310. As depicted, the water sprays 310 may be located above the effluent pipe 202, although it is to be understood the water sprays 310 may be located in any suitable location. The water sprays 310 may be supplied by a fresh water or fluid through ports 311 from a water or fluid source (not shown), or may be supplied from the tank 204.

In operation, the abatement system 300 may operate in a similar fashion to the abatement system 200, with the following differences. For example, the abated effluent which may flow from the reactor 208 through the waterfall pipe 206 may be cooled and/or processed and/or abated by the water sprays 310, in addition to the processing that is described with reference to FIG. 2. The water sprays 310 may intermingle with some portions of the effluent so as to wet some of the particles, etc. Such portions of the effluent that have been wetted by the water sprays 310 may fall into the tank 204. Some portions of the effluent may enter the effluent pipe 202 in a manner similar to that described with reference to FIG. 2. Of course, this particular additional processing may be incorporated into the abatement system 200 of FIG. 2.

Another difference between the operation of the abatement system 200 and the abatement system 300, is that in the abatement system 300, the eductor scrubbed effluent may exit the eductor 102 through the conduit 205 into the tank 204 below the fluid surface 230, as opposed to exiting the eductor 102 through the conduit 205 at about the level of the fluid surface 230. The scrubbed effluent may then flow into the bed scrubber 220 after bubbling out of the fluid 228 in the tank 204.

Yet another difference between the operation of the abatement system 300 of FIG. 3 and the abatement system 200 of FIG. 2 pertains to the source of motive fluid for the eductor 108. In FIG. 2, the source of pressurized motive fluid was described generally. In the abatement system 300 of FIG. 3, the source of motive fluid may be the tank 204. Thus, the pump 302 may draw the fluid 228 through the conduit 304. The pump 302 may then push the fluid through conduit 306 into the motive fluid connector 118 and the eductor nozzle (not shown) to form the eductor spray 108. Optionally, the pump 302 may force the fluid through the cooling apparatus 308. Cooling the motive fluid may result in better eductor 102 performance. For example, the cooler motive fluid may result in improved draw of effluent through the effluent pipe 202, improved abatement of particulates, and/or improved reaction of the motive fluid with elements of the effluent, such as, for example, halogens and/or hygroscopic particles, et cetera. In some embodiments, a filter (not shown) may be provided to reduce or prevent the transport of particulates through the pump 302 into the eductor 102.

FIG. 4 is a schematic side view of oxidation/eductor abatement system 400 provided in accordance with the present invention. As depicted, the abatement system 400 may include many of the components of the eductor apparatus 100 of FIG. 1, and of the abatement systems 200 and 300 of FIGS. 2 and 3. Such components are identified with the appropriate reference numerals from FIGS. 1, 2 and 3.

The abatement system 400 of FIG. 4 may be substantially similar to the abatement system 300 of FIG. 3, with the exception that the end of the eductor scrubbed effluent pipe 205 may be positioned to exhaust the eductor scrubbed effluent above the fluid surface 230.

In operation, the abatement system 400 of FIG. 4 may operate in a substantially similar fashion as does the abatement system 300 of FIG. 3, with the following exceptions. In the abatement system 400 of FIG. 4, the eductor scrubbed effluent that exits from the eductor scrubbed effluent conduit 205 may enter the tank 204 above the fluid surface 230, rather than below the fluid surface 230 as in the abatement system 300 of FIG. 3.

Although the eductor 102 has been depicted in a vertical orientation in FIGS. 2, 3 and 4, the eductor 102 may be placed in any other appropriate orientation including, but not limited to, horizontal.

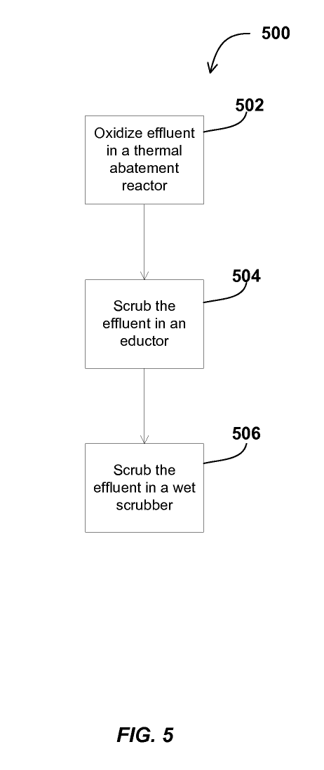

FIG. 5 is a flowchart depicting a method 500 for abating electronic device manufacturing tool effluent in an oxidation/eductor abatement system. In step 502, effluent from an electronic device manufacturing tool is oxidized in a thermal abatement reactor. In step 504, the effluent from the thermal abatement reactor is scrubbed in an eductor abatement apparatus. The eductor abatement apparatus may be similar to that described with regard to FIG. 1. In optional step 506, the effluent from the eductor abatement apparatus is scrubbed in a wet scrubber. The wet scrubber may be a packed bed and may have one or more beds containing beads, or another high surface area material, and one or more fluid sprayers. The fluid may be water or any other appropriate fluid.

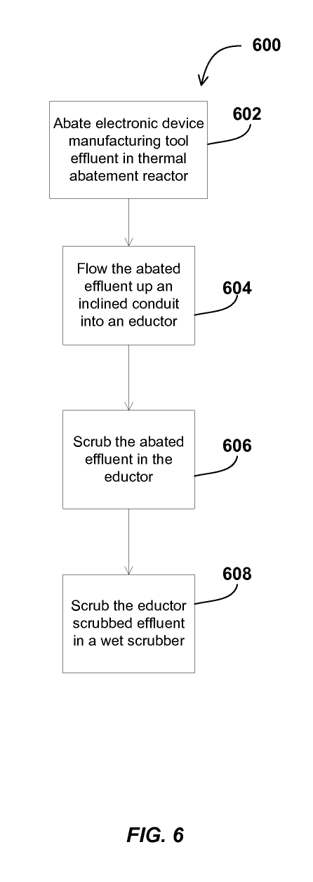

FIG. 6 is a flowchart depicting a method 600 for abating electronic device manufacturing tool effluent in an oxidation/eductor abatement system. In step 602, effluent from an electronic device manufacturing tool is abated in a thermal abatement reactor. The effluent may be cooled by water sprays in a cooling chamber such as the waterfall pipe described above with respect to FIG. 2. In step 604, the abated effluent is drawn up an inclined conduit into an eductor. As described above, the angle of the incline, the length of the conduit and the magnitude of the vacuum draw may be selected to ensure that particulates which are larger than a predetermined size, either in weight or diameter, and liquids, will not be drawn into the eductor 102. In step 606, the abated effluent is scrubbed in the eductor, and a significant amount of particulates which are entrained in the effluent are knocked down into the tank 204. In step 608, the eductor scrubbed effluent is optionally further scrubbed in a wet scrubber.

The foregoing description discloses only exemplary embodiments of the invention. Modifications of the above disclosed apparatus and methods which fall within the scope of the invention will be readily apparent to those of ordinary skill in the art.

Accordingly, while the present invention has been disclosed in connection with exemplary embodiments thereof, it should be understood that other embodiments may fall within the spirit and scope of the invention, as defined by the following claims.

The invention claimed is:

1. An electronic device manufacturing tool effluent abatement system comprising:
a thermal abatement reactor adapted to abate an effluent stream; and
an eductor adapted to receive the effluent stream from the thermal abatement reactor.

2. The abatement system of claim 1 wherein the thermal reactor comprises at least one of a burn oxidation reactor, an electro-thermal oxidation reactor and a plasma reactor.

3. The abatement system of claim 1 further comprising a wet scrubber adapted to receive the effluent stream from the eductor.

4. The abatement system of claim 1 further comprising an inclined conduit adapted to flow a portion of the effluent stream from the thermal reactor to the eductor.

5. The abatement system of claim 4 wherein the conduit is further adapted to segregate the effluent flow by preventing one or more of a liquid and particles larger than a predetermined size from being drawn into the eductor from the thermal reactor.

6. The abatement system of claim 1 wherein the eductor is further adapted to draw the effluent stream from the thermal reactor.

7. The abatement system of claim 1 further comprising a tank adapted to receive a fluid from the eductor.

8. The abatement system of claim 7 wherein the eductor is adapted to receive a second fluid from the tank.

9. The abatement system of claim 8 further comprising a cooling apparatus adapted to cool the second fluid.

10. The abatement system of claim 7 wherein the eductor is adapted to exhaust the effluent stream above the surface of a liquid in the tank.

11. The abatement system of claim 7 wherein the eductor is adapted to exhaust the effluent stream below the surface of the liquid in the tank.

12. The abatement system of claim 7 wherein the eductor is adapted to exhaust the effluent stream at the surface of the liquid in the tank.

13. A method for abating effluent from an electronic device manufacturing tool comprising:
oxidizing the effluent in a thermal abatement reactor; and
scrubbing the effluent from the thermal abatement reactor in an eductor.

14. The method of claim 13 wherein the step of scrubbing the effluent in an eductor comprises drawing the effluent into the eductor through an effluent port.

15. The method of claim 14 further comprising the step of preventing one or more of a liquid and particles larger than a predetermined size from being drawn into the eductor.

16. The method of claim 15 wherein the step of preventing one or more of a liquid and particles larger than a predetermined size from being drawn into the eductor comprises drawing the effluent up an inclined conduit into the effluent port.

17. The method of claim 15 wherein the step of preventing one or more of a liquid and particles larger than a predetermined size from being drawn into the eductor comprises introducing a motive fluid into the eductor at a pressure which creates a desired suction at the effluent port.

18. The method of claim 13 further comprising the step of using a fluid from the tank as a motive fluid in the eductor.

19. The method of claim 18 further comprising the step of cooling the fluid from the tank before using the fluid as the motive fluid in the eductor.

20. The method of claim 13 further comprising the step of forcing effluent from the eductor below the surface of a fluid in a tank.

21. The method of claim 13 further comprising the step of flowing effluent from the eductor above the surface of a fluid in a tank.

22. The method of claim 13 further comprising the step of flowing effluent from the eductor at the surface of a fluid in a tank.

23. The method of claim 13 further comprising the step of flowing the effluent from the eductor into a wet scrubber.

24. A method for abating effluent from an electronic device manufacturing tool comprising:
oxidizing the effluent in a thermal abatement reactor; and
scrubbing the effluent from the thermal abatement reactor with steam in an eductor.

25. The method of claim 24 wherein a source of the steam is at least one of a steam source external to the eductor, and a motive fluid, where at least a portion of the motive fluid has been converted to steam by the effluent.
